(19) United States
(12) Patent Application Publication
(10) Pub. No.: US 2011/0029996 A1
(43) Pub. Date: Feb. 3, 2011

(54) SYSTEM FOR AND METHOD OF ANALYSING THE CONSUMPTION OF TRANSMITTED AUDIO VISUAL CONTENT

(75) Inventors: Dominique Le Foll, Cambridge (GB); Kevin Mark Lingley, Saffron Waldon (GB)

Correspondence Address: KNOBBE MARTENS OLSON & BEAR LLP, 2040 MAIN STREET, FOURTEENTH FLOOR, IRVINE, CA, 92614, US

(73) Assignee: Amino Holdings Limited, Cambridge (GB)

(21) Appl. No.: 12/846,574

(22) Filed: Jul. 29, 2010

(30) Foreign Application Priority Data
Jul. 29, 2009 (GB) 0913151.7

(51) Int. Cl. H04H 60/33

(52) U.S. Cl. 725/9

(57) ABSTRACT

Systems and methods for analyzing the consumption of transmitted audio visual content are disclosed. The methods may comprise analyzing content viewed by consumers and updating the profiles of that content and/or the consumers accordingly, such as a method for analyzing the consumption of AV content by consumers comprising: assigning to each AV asset a tag comprising a unique asset ID and a multiple-entry asset qualification tag; assigning to each consumer a multiple-entry consumer qualification tag; and assigning to a consumer a new consumer qualification tag that is derived from a weighted combination of an existing consumer qualification tag associated with the consumer and an asset qualification tag of a selected AV asset, the consumer having requested the selected AV asset. The systems may comprise appropriately configured computing hardware, software, and connectivity for performing such methods, such as a calculation component configured to determine a new tag value for a consumer qualification tag associated with a consumer based on a weighted combination of a current tag value of the consumer qualification tag and a tag value of an asset qualification tag associated with an AV asset, the AV asset having been requested by the consumer; and a consumer qualification tag update component configured to set the tag value for the consumer qualification tag to the new tag value.

### CROSS-REFERENCE TO RELATED APPLICATIONS AND PATENTS

This application claims priority under 35 U.S.C. §119 to Great British patent application GB 0913151.7, filed Jul. 29, 2009, the disclosure of which is incorporated herein by reference.

### BACKGROUND OF THE INVENTION

1. Field of the Invention

The present invention relates to a system for and a method of analyzing the consumption of transmitted audio-visual (AV) content, and in particular to a system for and a method of adapting media content to the preferences of consumers.

2. Description of the Related Technology

Broadcasters and providers of AV content often wish to receive feedback from consumers of the content (for example, television viewers and radio listeners), in order to assess the consumers' acceptance ratings for the AV content transmitted by the content provider. This allows the provider to assess which AV content (e.g., programmes) were successful and had a high acceptance rating amongst the target audience. It also allows the provider to tailor the content offered to consumers to the preferences of those consumers, and to target advertisements to the consumers according to their preferences.

It is known that feedback from consumers of the AV content can be obtained manually, for example by form filling or by conducting a telephone survey. Alternatively, this data can be collected automatically by providing the consumer with a device that records the television or radio channels selected and the times at which those channels were selected. The content consumed by the consumer can then be determined from a look-up table based on the television and radio broadcast schedules.

Current large-audience analysis systems are therefore based on a feedback loop that records which channel is watched at a given time; that is, they record a time stamp associated with a content delivery channel that identifies when a user is consuming AV content and from where the content is being received. The collected information is then reorganized by a program with a look-up that can associate the time stamp and viewed channel information with a timetable that specifies the content that was present on the channel at the time stamp. The recording of viewer activity and the transmission of collected information back to the analysis system is generally automated and carried out by a single device.

Such a system is however generally only suitable for traditional broadcast transmissions in which the AV content is transmitted in a linear manner: i.e. the programmes (for example) are transmitted at specific times according to a predetermined broadcasting schedule. Such systems are not suitable for non-linear transmission modes where the AV content is not transmitted according to a fixed timetable. AV content transmitted in a non-linear fashion may include, for example, catch-up TV, video on demand (VOD), Internet radio and podcasts. Provision of AV content on media using non-linear models is increasingly prevalent and is starting to replace traditional broadcast transmission.

Known audience analysis systems also suffer from reduced efficiency when the number of offered audio-visual channels becomes larger (including multiple TV channels, specialized channels, radio etc). Furthermore, current systems do not easily allow dynamic adaptation of content ratings, wherein the expected success of a programme in a given population is rated in relation to its prior viewings.

### SUMMARY OF CERTAIN INVENTIVE ASPECTS

The systems and methods of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Inventive Embodiments” one will understand how the sample features of this invention provide advantages in large-audience analysis and targeted advertising. More specifically, embodiments of the present invention are concerned with providing a consumption-based feedback loop, which optionally can be used to improve the acceptability of the AV content suggested or delivered to a user or a group of users.

Embodiments of the invention are applicable to multiple uses, including consumption and habit analysis, customized or individualized content offering, and customized or individualized advertising. The invention is applicable to multiple transmission modes (e.g., broadcast, multicast and unicast data transmission modes for the transmission of AV media) in either a linear or non-linear fashion.

An aim of the invention is to provide a method and a system that mitigates at least some of the aforesaid disadvantages. In particular, a preferred goal of the invention is to provide a viable method for collecting information relating to non-linear AV consumption and large numbers of AV channels. A further preferred objective is to provide an analysis model that can deliver a variable granularity of analysis, ranging from global populations down to individuals.

According to one aspect of the invention there is provided a method for analyzing the consumption of AV content by consumers, in which the AV content comprises a multiplicity of AV assets, the method comprising: assigning to each AV asset a tag that includes a unique asset ID and a multiple-entry asset qualification tag, assigning to each consumer a multiple-entry consumer qualification tag, in which upon a consumer making a request for a particular AV asset, that consumer is assigned a new consumer qualification tag that is derived from a weighted combination of the existing consumer qualification tag and the asset qualification tag of the selected AV asset.

Provided that the qualification tags of the AV assets properly reflect the content of the assets, the multiple values within a consumer's qualification tag will converge upon a set of values that represents the interests of the consumer.

Advantageously, upon a consumer making a request for a particular AV asset, that AV asset is assigned a new asset qualification tag that is derived from a weighted combination of the AV asset's existing asset qualification tag and the consumer qualification tag of the consumer.

A similar process can be applied in reverse such that the tags for the content are modified based on the characteristics of the consumers that choose that content.

Therefore, from a second aspect, this invention provides a method for characterising AV assets to be delivered to consumers, where each consumer has a multiple-entry qualification tag comprising: assigning to each AV asset a tag that includes a unique asset ID and a multiple-entry qualification tag, in which upon a consumer making a request for a particular AV asset, that AV asset is assigned a new qualification tag that is updated to a weighted combination of the AV asset's existing qualification tag and the qualification tag of the consumer.

When a particular AV asset has been requested several times by different consumers, the values in its qualification tag should converge to those that represent a consumer that might wish to consume that content.

In either case, most typically, each of the values represents a characteristic of the content and it is assigned a numerical score that indicates the extent to which that particular piece of content possesses that characteristic. For each of these, a value of 0 might be assigned where the content is neutral in relation to the characteristic, a positive value where the content possesses that characteristic, or a negative value where the content is contrary to that characteristic. Where a non-zero score is assigned, the magnitude of that score indicates the extent to which the content possesses that characteristic. For instance, there may be values that represent genres such as romance, horror, science-fiction; values that represent aspects of its content such as violence, action, dialogue; and values that represent the target audience such as women, children, old people, and so forth.

Advantageously, each of the consumer qualification tag entries represents a characteristic of AV content and is assigned a numerical value that indicates the interest of that particular consumer in AV content that possesses that characteristic.

Advantageously, for each value, a score of 0 is assigned where the consumer's interest is neutral in relation to the characteristic, a positive value where the consumer has a positive interest that characteristic, or a negative value where the consumer is disinterested in that characteristic. Preferably, the magnitude of the value indicates the consumer's degree of interest in that characteristic.

Typically, the qualification tag will have somewhere between 10 and 100 values.

The consumer's qualification tag may be associated with an individual person or it may be associated with a hardware device that is used to access the content. In the later case, the method may perform an analysis to identify whether the scores in the consumer's qualification tag vary consistently from one time of day to another. This may indicate that the hardware device is accessed by different consumers at different times of day.

From a third aspect, the invention provides a method of predicting which of a plurality of AV assets is likely to be favored by a consumer, comprising analyzing the consumption of a consumer by a method according to the first aspect of the invention, and comparing the qualification tag of the consumer with the qualification tag of each AV asset in order to identify those assets that have a qualification tag most similar to that of the consumer.

In this context, advertisements are treated in the same way as any other AV asset when considering which advertising content should be offered to which consumer.

From a fourth aspect, the invention provides a method of suggesting content to a consumer comprising identifying AV assets that are likely to be favored by a consumer by a method embodying the third aspect of the invention and presenting a list of the identified content to the consumer whereby the consumer can select content from the list.

From a fifth aspect, the invention provides a method of presenting targeted content to a consumer comprising identifying AV assets that are likely to be favored by a consumer by a method embodying the third aspect of the invention and delivering that content to the consumer.

In such a method, the identified content may be delivered in combination with other content. For example, the identified content may include advertising material to be delivered in combination with content selected by the consumer.

According to a sixth aspect of the invention there is provided a system for analyzing the consumption of AV content by consumers, wherein the AV content comprises a multiplicity of AV assets, the system comprising a content provider that is constructed and arranged to assign to each AV asset a tag that includes a unique asset ID and a multiple-entry asset qualification tag, and to assign to each consumer a multiple-entry consumer qualification tag, and an analysis system that is constructed and arranged to detect a request by a consumer for a particular AV asset, to derive a new consumer qualification tag from a weighted combination of the existing consumer qualification tag and the asset qualification tag of the selected AV asset, and to assign the new consumer qualification tag to the consumer.

Advantageously, the analysis system is constructed and arranged to derive a new asset qualification tag from a weighted combination of the existing asset qualification tag and the consumer qualification tag, and to assign the new asset qualification tag to the AV asset.

### BRIEF DESCRIPTION OF THE DRAWINGS

FIG. 1 illustrates a prior art method for the collection of broadcast AV content consumption data by custom hardware and delivery to a custom analysis centre, where the analysis is restricted to look-up by time versus channel.

FIG. 2 illustrates a method according to an embodiment of the invention, in which feedback is collected independently of time to allow the measurement of consumption of non-linear content such as video on demand and catch-up TV in addition to linear broadcast TV.

FIG. 3 illustrates the matching of content to consumers by the numerical convergence of descriptive consumer and asset tags.

FIG. 4 illustrates the matching of consumers to content by the numerical convergence of descriptive consumer and asset tags.

FIG. 5 illustrates a simple example of statistical convergence.

FIG. 6 illustrates the matching of consumers to time slots by the numerical convergence of descriptive consumer and time slot tags.

### DETAILED DESCRIPTION OF CERTAIN INVENTIVE EMBODIMENTS

The following detailed description is directed to certain specific sample aspects of the invention. However, the invention can be embodied in a multitude of different ways as defined and covered by the claims. In this description, reference is made to the drawings wherein like parts are designated with like numerals throughout.

In the present application, the term “AV content” includes any audio and/or video material that is transmitted from a provider to a consumer using various media, including for example television programmes, films, radio programmes, music, images and so on.

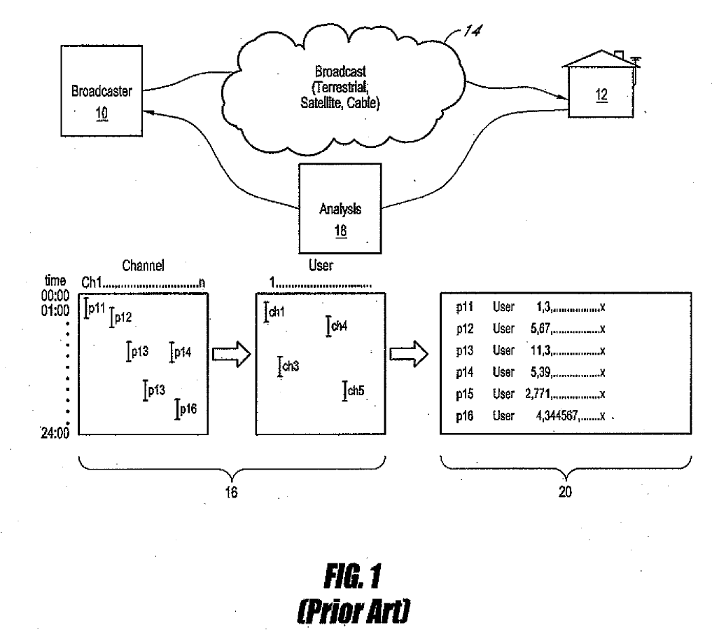

In FIG. 1, there is shown a known method for the collection of broadcast content consumption data. The method is carried out within a distribution system comprising a content provider 10 (for example a television broadcaster), which transmits AV content to one or more consumers 12 by means of a conventional transmission medium 14, for example by terrestrial broadcast transmission, satellite broadcast, cable connection or via the internet. The consumer 12 selects and receives the AV content using traditional receiving equipment (not shown). The receiving equipment includes a device that monitors the AV channels selected by the consumer and the times at which those selections are made. This data 16 (the channel selections and the corresponding date stamps) together with data identifying the consumer is transmitted back to the provider by any suitable means 18, for example via a telephone line or an internet link. The received data is then analyzed by the provider, the analysis being conducted by means of a look-up process in which the AV content consumed are identified by comparing the channel selections and date stamps with the appropriate AV content broadcast schedules. This provides information 20 regarding the numbers and identities of consumers for all of the transmitted AV content.

Such a system as described above provides good feedback results for traditional broadcast systems. Indeed, it is only possible to obtain such feedback from the consumer's receiver because the broadcaster has no way to determine directly whether a consumer is receiving a broadcast programme.

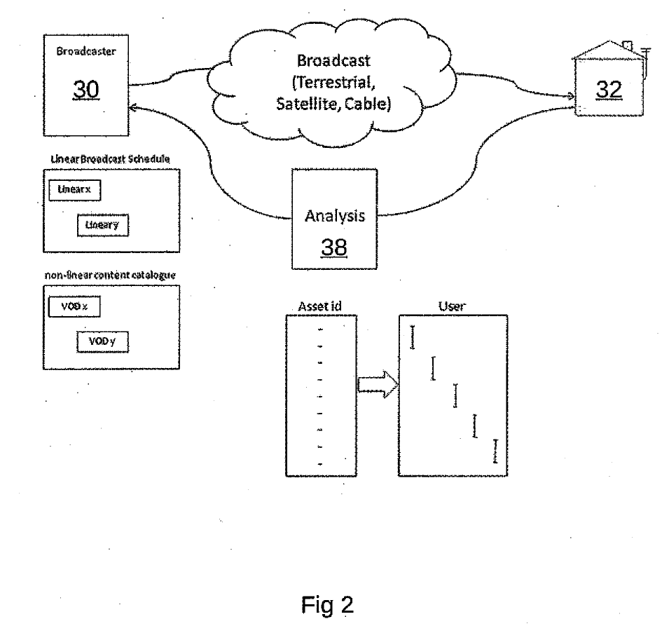

As shown in FIG. 2, an embodiment of the invention can provide information to a content provider about the activities of a consumer in relation to content that is distributed by broadcasting or other means. As before, it is implemented in a system that has a content provider 30 that can transmit AV content to consumers 32, and an analysis system 38 for returning data from the consumers 32 to the provider 30.

Embodiments of the invention associate an asset tag with every AV asset (an AV asset being a complete unit that will be consumed by a consumer, such as a TV show, a TV series, a film, a software download, a music file, and so forth). The asset tag contains a unique asset ID and a multiple-entry qualification tag.

The unique ID allows an AV asset to be identified uniquely by the system, independently of any time-stamp information. This is a key requirement to operate in a non-linear distribution model.

The qualification tag of an AV asset contains numerous entries that represent the content of that AV asset and therefore the expected level of interest in that asset to a population of consumers. The entries may be categorized in many different ways. These categories might include the genre to which the content belongs, its target audience, and aspects of the content that might appeal to those consumers with certain “colorations” of interest, examples of coloration including feminine orientation, non-violence, action, arty, romantic, popular, high education, Latin America etc. In some embodiments, every AV asset has a qualification tag with entries representing the same set of categories, such that AV assets can be meaningfully compared with one another by comparing their qualification tags.

In some embodiments, the values of the entries in the asset qualification tag are represented by numbers where zero represents a neutral value, positive numbers represent significant content (the highest number representing the greatest content), and negative numbers an insignificant content (the lowest number representing the least content).

Embodiments of the invention can work with any number of entries in the qualification tag, but to offer a good ratio of convergence versus the volume of collected data, it would typically use about 10 entries as a minimum and up to about 100 as a practical maximum. However, if necessary, these boundaries can be exceeded if a particular circumstance finds it to be appropriate.

The values of the entries within the qualification tag may be initialized with seed scores by the time that the AV asset is brought into the distribution system. Seeding the entries in the qualification tag with likely values is preferable but not essential: they may alternatively be set initially to neutral values. Seeding initial likely values will increase the rapidity of convergence of the data within the tags. Manual solutions based on AV content editors, automatic analysis based on AV producers' and critics' metatags, or a mix of both or any other method could be used to seed the values of the qualification tag. The methods used to seed the values within qualification tags are multiple and outside the scope of the invention. Entries that cannot be seeded by this process may be set to a neutral value.

When a consumer selects a given AV asset, the unique asset ID is recorded by the analysis system 38 with optionally the time stamp of the selection, the consumer level of interest for this asset and various other parameters, such as which device is used to play the AV asset (TV, PC, mobile phone etc).

The unique asset ID is used by the analysis system 38 to identify, during the feedback process, which exact AV asset has triggered the end user interest independently of any time stamp or channel information.

The optional time stamp information may be used by the analysis system 38 to fine-tune the analysis of the feedback based on period of the day or day of the week, independently of the asset itself. (This feature proves to be powerful when embodiments of the invention are used to offer customized AV content or targeted advertisement.)

The provider 30 also maintains a list characterizing the interests of each consumer that takes its content. As with the AV content assets, each consumer has an associated multiple-entry qualification tag. Each entry in a consumer's qualification tag has the same meaning as the corresponding entry in the qualification tag of an AV asset, but represents the individual consumer's preference for that aspect of content.

The consumer level of interest is a grading which can be collected automatically from the consumer's behavior or from formal consumer feedback, for example. Automatic collection might include, but is not limited to, selecting more information on a proposed AV asset, starting to consume (e.g. watch) the asset, consuming the asset completely. Manual collection may include, but is not limited to, asking the consumer to rate the consumed asset by a notation system, a multiple entries qualification or a simple thumb up/down selection.

The extra information which can be collected by the embodiment to improve the quality of the feedback loop and optional associated offering of customized AV contents might include, but not be limited to, sex of the consumer, age band, individual group type (e.g. teenager, family, bachelor etc).

Associated with each consumer is a multiple-entry consumer qualification tag that is similar to the asset qualification tag associated with any AV asset. The values of the entries in the consumer qualification tag are represented by numbers where, for example, zero represents a neutral interest value in a particular category of content, a positive number represents an attraction (the highest number representing the greatest attraction), and a negative number represents a rejection or aversion to that category of content (the lowest number representing the strongest aversion).

The consumer qualification tag may be associated with an individual. Alternatively the consumer qualification tag may be associated with a device (for example a television receiver) that is used to consume the AV asset. In both cases, the tag can optionally be multiplied to offer multiple entries for each period of the day and each day of the week (e.g. one tag per hour for each day of the week). For simplicity, all models of implementation of this tag are called a “consumer qualification tag” later in this document.

The above described tags can be advantageously stored and maintained on computer readable media for use by processes running on one or more general purpose computers or processors or their functional equivalents, such as virtualized hardware. In more preferred embodiments, the analysis systems 38 run on computer systems running operating systems in the Microsoft Windows™, Apple MacOS™, or UNIX™ families. An analysis system 38 may, for example, run on a computing system having multiple processors or processor cores, multiple terabytes of persistent storage (e.g., hard disk drive storage), and multiple gigabytes of solid-state RAM. A practitioner will appreciate that the evolution of hardware and software and the requirements of a specific embodiment will all influence the need for hardware in any particular embodiment. Typically, the broadcaster or content provider 30 will operate or have access to an interface to computing hardware which, among other features, provides access to AV content that may be stored on computer readable media and to the outputs of the analysis system 38, said outputs also stored on computer readable media. Similarly, computing hardware accessible, deliberately or not, by the consumer 32, may be used to create input for the analysis system 38, said inputs stored on computer readable media. In an embodiment, the consumer 32, content provider 30, and analysis system 38 may use common or distinct computing platforms, and each may have multiple computing platforms.

A concise description of a sequence of operation of the embodiment will now be presented.

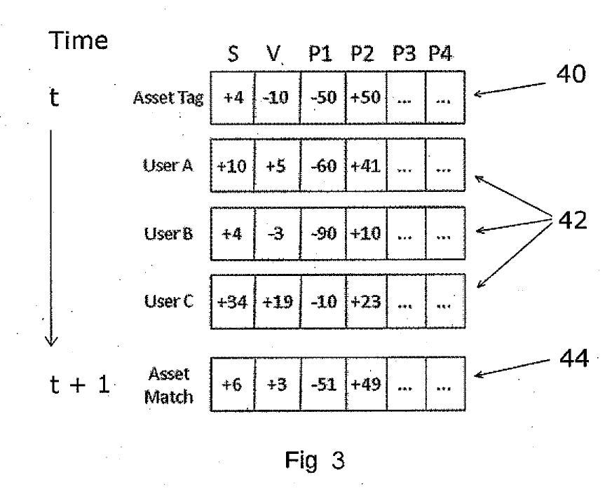

Each AV asset is associated with a unique ID tag and a multiple-entry qualification tag, which has optionally been seeded with initial values. An example is shown in FIG. 3, wherein the asset tag 40 has entries in the categories labelled S, V, P1, P2, P3 and P4. Category S may for example represent content of a sexual nature, V may represent violence, and P1 to P4 other categories of content. In this case, the particular AV asset has values of +4, −10, −50, +50 and so on, representing some mild sexual content, little violence, etc.

When a consumer selects an AV asset for consumption, the unique ID of the asset and the consumer qualification tag are returned to a consumption analysis engine 38. If present, any extra information is returned at the same time.

The asset ID is used to look up the asset qualification tag of the selected AV asset. The consumption analysis engine 38 weighs the asset qualification tag against the consumer qualification tag and generates a new weighted asset qualification tag. The weighting operation provides a rapid convergence without being disrupted by an occasional exception.

In the example shown in FIG. 3, the asset tag 40 at time t is weighed against three consumer tags 42 representing users A, B and C to generate a new weighted asset tag 44 at time t+1. In category S, the asset tag has a value +4 whereas the users consuming that asset have tag values of +10, +4 and +34. In this case, the convergence function increases the value of the asset tag by 0.5 if the value of the user tag exceeds the value of asset tag by 10 or less, and increases the value of the asset tag by 1.0 if the value of the user tag exceeds the value of asset tag by more than 10, and then rounds the result. The result of the weighting process is to increase the value of the asset tag in category S from +4 to +6.

In category V, a different convergence function is used, which simply averages the existing asset tag value with the user tag values (−10+5−3+19=11, 11/4=2.75, which is rounded to 3). The result of the weighting process is to increase the value of the V asset tag from −10 to +3.

The values of the asset tags in each of the other categories are modified in a similar manner by weighing the existing value of the asset tag against the corresponding values of the consumer tags. The convergence functions used to calculate the new weighted values of the asset tag are selected according to the requirements of the provider: many different convergence functions may be suitable, including moving average functions, single step functions, linear or non-linear functions, parametric or non-parametric statistical analysis, or factorial statistical analysis. The choice of the most appropriate convergence functions is however irrelevant for the purposes of the present invention.

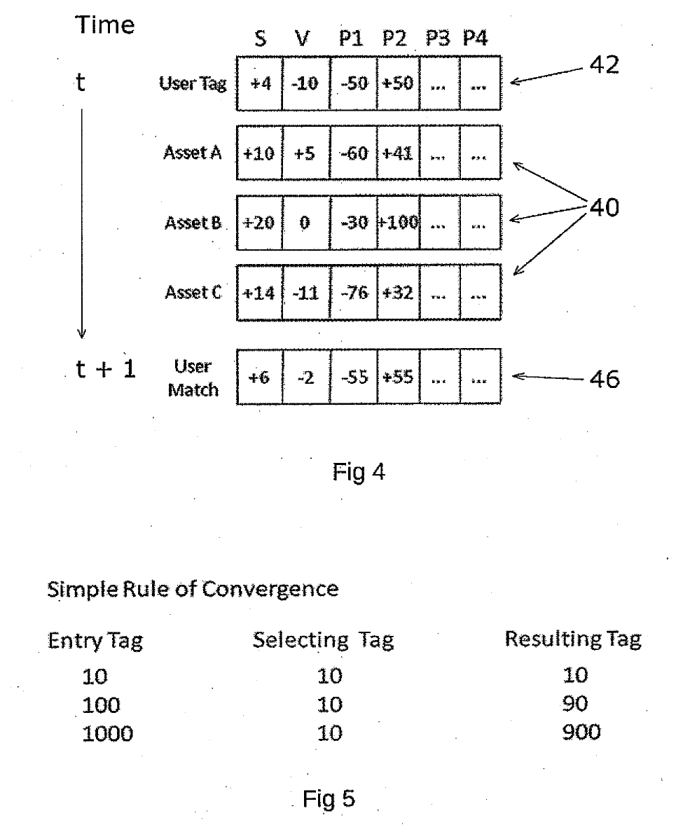

As shown in FIG. 4, the consumption analysis engine 38 may also do a converse operation and weigh the consumer qualification tag 42 against the asset qualification tags of the selected AV assets and generate a new weighted consumer tag 46 to replace the previous one. It will be noted that the values of the new weighted consumer tag 46 differ by only a few units from the values of the previous user tag 42, despite occasional large discrepancies between the values of the consumer tag and the asset tags. The weighting process therefore provides a rapid convergence without being disrupted by an occasional exception.

When the intention is to improve the acceptability of proposed content to a consumer or a group of consumers, the consumer qualification tag is compared with the asset qualification tags of the available AV assets. The comparing process identifies which AV assets have a greater chance of being selected by an individual consumer. By this process, there is provided the capability of presenting individualized AV content which has a high probability of acceptability. This is because AV assets with qualification tags similar to the consumer qualification tag of a particular consumer are likely to be preferred by that consumer. The consumer can thus be offered a reduced listing of AV content in which that consumer is likely to be interested, or that AV content can be offered preferentially to the consumer.

The knowledge of consumer qualification tags also allows the targeting of advertisements by extending the preference model. This allows advertisements to be selected and presented to the consumer according to the known interests of the consumer.

FIG. 5 illustrates one way in which a qualification tag of an AV asset can be adapted in response to a choice made by a consumer. The column labelled “Entry Tag” represents a value contained in one of the entries of the qualification tag of the AV asset before the selection was made. The column labelled “Selecting Tag” is the value of the corresponding entry in the consumer qualification tag. The column labelled “Resulting Tag” is the score that will be contained in the new qualification tag to be associated with the AV asset, following adjustment as a result of the selection made by the consumer. It can be seen that where the entry tag and the selecting tag have the same value as in the first row, the resulting tag is unchanged. However, when the value of the selecting tag is less than the value of the entry tag as in rows 2 and 3, the value of the resulting tag is reduced. A similar procedure is used to update the consumer qualification tag of a consumer whenever the consumer selects an AV asset.

This weighting process typically allows for a quicker convergence of the end user multi-entry qualification tag against the asset than it does for of the asset qualification tag against the consumers.

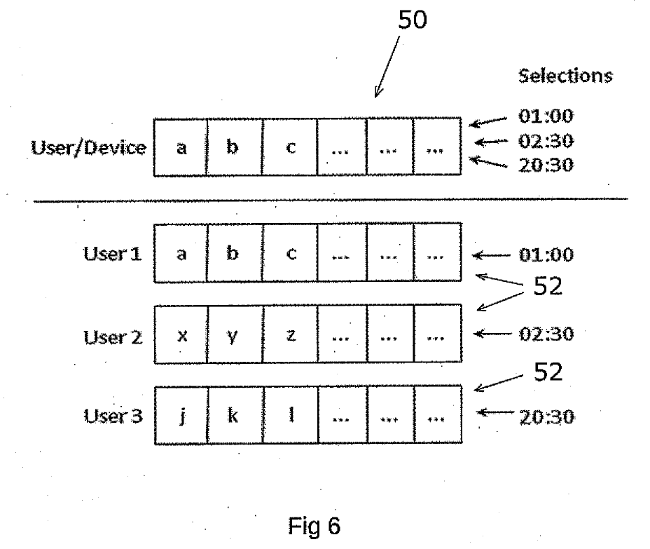

FIG. 6 illustrates an embodiment in which the consumer qualification tag 50 is associated with a device (for example a television receiver), rather than an individual. In this case, the tag is multiplied to offer multiple entries for different periods of the day and days of the week (e.g. one tag per hour for each day of the week). This allows the system to take account of regular changes in the make up of the audience consuming the AV assets (for example, children in the early evening, adults later in the evening and families at weekends). These different audiences may well have different preferences for AV content. By dividing each day and each week into different periods and treating each of these periods as a different user 52, the system is able to recognize viewing patterns and tailor available content according to the preferences of those audiences.

In this embodiment, the unique ID and the multi-entry qualification tags can be implemented as XML documents where the qualification levels are represented by numbers where zero represents a neutral interest value, positive numbers an attraction (the highest number is the best), and negative numbers a rejection (the lowest number is the worst).

In environments in which a consumer accesses content through a web browser, an HTML cookie can be stored on the consumer's computer to give access to the end user multi-entry qualification tag. According to the preferences of the implementer, the cookie may contain data that defines the end user multi-entry qualification tag, or it may contain a reference to a database in which the data that defines the end user multi-entry qualification tag is stored centrally.

The methods of this embodiment can be used to generate lists of content that a consumer might wish to use in future. For example, it may be used to generate lists of further content of interest to a consumer within a menu or page of content items from which a user is making a selection.

Alternatively or additionally, the methods of this embodiment can be used to select from a pool of advertising content that can be delivered to a consumer in combination with selected content. For example, when a consumer selects a video to watch on-line, the video may be displayed on a web page that also includes advertising material that is selected as being of likely interest to the consumer.

In a broadcast, multicast and unicast environment, where the audio visual asset multi-entry qualification tags are distributed with the catalogue offering them, the reduction of AV assets offered to the consumer is performed at the consumer side. In a unicast environment where the consumer qualification tag is made available to the catalogue server entity, the reduction of the AV assets offered to the consumer is performed by the catalogue server entity.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

All of the systems described above may include one or more general purpose computers or processors and/or may include one or more special purpose computers or processors. All of the processes described above may be embodied in, and fully automated via, software code modules executed by one or more general purpose computers or processors, or alternatively, by specialized computer hardware. The code modules may be stored in any type of computer-readable medium or computer storage device. The various computer hardware resources (physical computers, processors, storage devices, etc.) used to run the disclosed software components, and to implement the associated databases, collectively form and operate as a computerized modeling machine or system. The various processing nodes of the computerized modeling machine or system may communicate over one or more computer networks, and may, but need not, be co-located.

What is claimed is:

1. A computing hardware system for analyzing the consumption of AV content by consumers, the system comprising:
a calculation component configured to determine a new tag value for a consumer qualification tag associated with a consumer based on a weighted combination of a current tag value of the consumer qualification tag and a tag value of an asset qualification tag associated with an AV asset, the AV asset having been requested by the consumer; and
a consumer qualification tag update component configured to set the tag value for the consumer qualification tag to the new tag value.

2. The system of claim 1, wherein the update component is configured to set the tag value only if the AV asset has been viewed by the consumer.

3. A computing hardware system for analyzing the consumption of AV content by consumers, the system comprising:
a calculation component configured to determine a new tag value for an asset qualification tag associated with an AV asset based on a weighted combination of a current tag value of the asset qualification tag and a tag value of a consumer qualification tag associated with a consumer, the AV asset having been requested by the consumer; and
an asset qualification tag update, component configured to set the tag value for the asset qualification tag to the new tag value.

4. The system of claim 3, wherein the update component is configured to set the tag value only if the AV asset has been viewed by the consumer.

5. The system of claim 3, further comprising:
a second calculation component configured to determine a new consumer tag value for the consumer qualification tag associated based on a weighted combination of a current tag value of the consumer qualification tag and the current tag value of the asset qualification tag; and
a second consumer qualification tag update component configured to set the tag value for the consumer qualification tag to the new consumer tag value.

6. The system of claim 3, further comprising:
an asset initiation component configured to associate an AV asset ID with an asset qualification tag; and
a consumer initiation component configured to associate a consumer ID with a consumer qualification tag.

7. The system of claim 5, wherein the first and second calculation components are the same component and the first and second update components are the same component.

8. A method for analyzing the consumption of AV content by consumers, in which the AV content comprises a multiplicity of AV assets, the method comprising:
assigning to each AV asset a tag comprising a unique asset ID and a multiple-entry asset qualification tag;
assigning to each consumer a multiple-entry consumer qualification tag; and
assigning to a consumer a new consumer qualification tag that is derived from a weighted combination of an existing consumer qualification tag associated with the consumer and an asset qualification tag of a selected AV asset, the consumer having requested the selected AV asset,
wherein the method is performed using one or more computerized systems that comprise computer hardware and software modules configured to perform the method.

9. A method according to claim 8, in which upon a consumer making a request for a particular AV asset, that AV asset is assigned a new asset qualification tag that is derived from a weighted combination of the AV asset's existing asset qualification tag and the consumer qualification tag of the consumer.

10. A method according to claim 8 in which at least one of the asset qualification tag entries represents a characteristic of the content and is assigned a numerical value that indicates the extent to which that particular AV asset possesses that characteristic.

11. A method according to claim 10 in which each asset qualification tag is assigned a baseline value where the content is neutral in relation to the characteristic, a value greater than the baseline where the content possesses that characteristic, or a value less than the baseline where the content is contrary to that characteristic.

12. A method according to claim 11 in which baseline value is 0.

13. A method according to claim 11 in which, for each non baseline value, the value has a magnitude that indicates the extent to which the content possesses that characteristic.

14. A method according to claim 8, in which at least one of the consumer qualification tag entries represents a characteristic of AV content and is assigned a numerical value that indicates the interest of that particular consumer in AV content that possesses that characteristic.

15. A method according to claim 14 in which each consumer qualification tag is assigned a numerical baseline value where the consumer's interest is neutral in relation to the characteristic, a value greater than the baseline where the consumer has a positive interest in that characteristic, or a value less than the baseline where the consumer is disinterested in that characteristic.

16. A method according to claim 11 in which baseline value is 0.

17. A method according to claim 15 in which, for each non-baseline value, the value has a magnitude that indicates the consumer's degree of interest in that characteristic.

18. A method according to claim 8 in which the qualification tags have between 10 and 100 values.

19. A method according to claim 8 in which the qualification tags include values that represent genres.

20. A method according to claim 8 in which the qualification tags include values that represent the target audience.

21. A method according to claim 8 in which the qualification tags include values that represent aspects of the content of the AV asset.

22. A method according to claim 8 in which the consumer qualification tag is associated with an individual.

23. A method according to claim 8 in which the consumer qualification tag is associated with a hardware device that is used to access the AV content.

24. A method according to claim 23 in which the method further comprises determining analysis whether the values in the consumer qualification tag vary consistently from one time of day to another.

25. A method of identifying which of a plurality of AV assets is likely to be favored by a consumer, the method comprising:
analyzing the AV consumption of a consumer by associating with each AV asset a tag that includes a unique asset ID and a multiple-entry asset qualification tag;
associating with a consumer a multiple-entry consumer qualification tag;
upon the consumer making a request for a particular AV asset, assigning to the consumer a new consumer qualification tag that is derived from a weighted combination of the existing consumer qualification tag and the asset qualification tag of the requested AV asset;
comparing the consumer qualification tag of the consumer with the asset qualification tag of each AV asset;
and identifying those assets that have qualification tags similar to the consumer qualification tag of the consumer.

26. A method of suggesting AV content to a consumer, the method comprising:
analyzing the AV consumption of a consumer by assigning to each of one or more AV assets a tag that includes a unique asset ID and a multiple-entry asset qualification tag;
assigning to a consumer a multiple-entry consumer qualification tag;
upon the consumer making a request for a AV asset assigning to the consumer a new consumer qualification tag that is derived from a weighted combination of the existing consumer qualification tag and the asset qualification tag of the requested AV asset;
comparing the consumer qualification tag of the consumer with the asset qualification tag of each AV asset;
identifying one or more AV assets that have qualification tags similar to the new consumer qualification tag; and
presenting a list of the identified AV assets to the consumer whereby the consumer can select AV content from the list.

27. A method according to claim 26, further comprising delivering the selected AV content to the consumer.

28. A method according to claim 27 in which the selected AV content is delivered in combination with other content.

29. A method according to claim 27 in which the identified AV content includes advertising material to be delivered in combination with the selected AV content.

30. A system for analyzing the consumption of AV content by consumers, wherein the AV content comprises one or more AV assets, the system comprising a content provider that is constructed and arranged to assign to each AV asset a tag that includes a unique asset ID and a multiple-entry asset qualification tag, and to assign to each consumer a multiple-entry consumer qualification tag, and an analysis system that is constructed and arranged to detect a request by a consumer for a particular AV asset, to derive a new consumer qualification tag from a weighted combination of the existing consumer qualification tag and the asset qualification tag of the selected AV asset, and to assign the new consumer qualification tag to the consumer.

31. A system according to claim 30, in which the analysis system is constructed and arranged to derive a new asset qualification tag from a weighted combination of the existing asset qualification tag and the consumer qualification tag, and to assign the new asset qualification tag to the AV asset.
